(19) United States
(12) Patent Application Publication
(10) Pub. No.: US 2015/0135275 A1
(43) Pub. Date: May 14, 2015

(54) AUTHORIZATION SERVER SYSTEM, CONTROL METHOD THEREFOR, AND STORAGE MEDIUM

(71) Applicant: CANON KABUSHIKI KAISHA, Tokyo (JP)

(72) Inventor: Hayato Matsugashita, Kawasaki-shi (JP)

(21) Appl. No.: 14/536,470

(22) Filed: Nov. 7, 2014

(30) Foreign Application Priority Data
Nov. 11, 2013 (JP) 2013-233498

(51) Int. Cl. H04L 29/06

(52) U.S. Cl. CPC H04L 63/08
USPC 726/4

(57) ABSTRACT

An authorization server system configured to restrict the usage of a service provided via a network includes an authorization processing unit, a verification processing unit, a determination unit, and a restriction unit. The determination unit is configured to determine whether the number of uses of the mathematical function called by the client to use the service is greater than the upper limit when the authorization information is issued by the authorization processing unit and when the authorization information is verified by the verification processing unit.

### BACKGROUND OF THE INVENTION

1. Field of the Invention

The present invention relates to an authorization server system that can delegate user authority to a client, a method for controlling the authorization server system, and a storage medium.

2. Description of the Related Art

The usage of web services, which are generally referred to as cloud services accessible via the internet, has been recently increasing. For example, the cloud services include managing a client relationship using a customer relationship management (CRM) service and performing information transmission/collection using a social networking service (SNS) in real time. The cloud services are available not only for personal use but also for business use. Further, there are numerous cloud services each including an application programming interface (API) of a web service opened to the public. Another application (or cloud service) can use the service via the API. The usage of a mashup function, which constitutes a plurality of cloud services as if it can be regarded as a single web service to enable each of respective cloud services to use an API of another cloud service opened to the public, has been increasing.

On the other hand, some problems may occur if the mashup function for cooperatively using a plurality of cloud services is frequently used. For example, user data or personal information may leak undesirably if an excessive amount of information is exchanged among a plurality of cloud services. In general, it is not desired for each cloud service to acquire user data and personal information unnecessarily. Further, providing user data and personal information to a cloud service that the user does not want to cooperate with should be strictly prevent. However, it is generally desired for each service provider that a system (or configuration) cooperatively used among cloud services is easy to install.

OAuth 2.0 is a standard protocol capable of realizing authorization cooperation, which is formulated to solve the problem that may occur in the above-mentioned situation. For example, the OAuth 2.0 is the protocol that permits a service B recognized by the user to access the API that can acquire user data managed by a service A. The service A clearly indicates the range of a resource accessed by the service B and obtains an explicit authorization from the user with respect to the access to the API by the service B. The explicitly performed authorization by the user is referred to as authorization operation.

If the user performs an authorization operation, the service B acquires an authorization token from the service A proving that the access has been authorized by the service A. Using the authorization token enables the service B to access the API of the service A. The user authorization operation (i.e., a user conduct to permit the access to a resource), more specifically, the conduct to delegate authority to use the service A to the service B is referred to as “delegation of authority”.

Further, according to the OAuth 2.0, it is necessary to authenticate the service B to prevent spoofing as the service B. The preparation necessary to authorize the service B is that the service A issues authentication information (more specifically, client ID and secret) about the service B and set the authentication information to the service B beforehand. Hereinafter, the service B is referred to as a client of the service A. Further, according to the OAuth 2.0, it is feasible to separately constitute an authorization server that performs the user authorization operation, the authorization token issuance, and the client authentication described above, and a resource server that manages user data as a resource and opens an API, as a web service, to the public. In this case, the service B acquires delegation of authority from the user, acquires an authorization token from the authorization server, and uses the API of the resource server based on the authorization token. The resource server is configured to request the authorization server to verify the acquired authorization token, permit the access to the resource only when access permission is obtained, and transmit a response including required data to the service B.

As another technique, it is conventionally known to monitor the API used by a client per unit time. The technique intends to prevent the quality of the entire service from deteriorating when the API is excessively used by a specific client. In particular, a pay service is generally configured to be charged according to a usage amount of the service and refuse the access from a user if the number of uses per unit time exceeds an upper-limit value determined beforehand. This is because the pay service is basically available based a contract agreed between a service provider and each user, and the pay service shall be responsible for stable provision of the service according to the contents of the contract. For example, Service Level Agreement (SLA) is well known as a system capable of assuring the quality of a service. For example, the minimum speed of a service to be provided and the upper limit of unavailable time can be defined by the SLA. Each user pays a usage fee for the quality of a service defined by the SLA. Further, the contents defined by the SLA include penalties to be imparted on the service provider in case of nonattainment of the defined quality, and guarantees to be secured for users (such as reduction of usage fee). Accordingly, the pay service is strictly required to assure the quality defined by the SLA. Setting an upper limit with respect to the API usage amount and refusing the access upon exceeding the upper limit is important to prevent the quality of the service from deteriorating.

### SUMMARY OF THE INVENTION

However, in a system in which a client acquires delegation of authority from a user and accesses a cooperation target server, like the configuration according to the OAuth 2.0, there is not any effective system or configuration that enables the client to appropriately use the API considering the upper limit with respect to API number-of-uses.

The present invention is directed to a technique capable of assuring a client of appropriate API usage in a system in which the client acquires delegation of authority from a user and accesses a cooperation target server.

According to an aspect of the present invention, an authorization server system configured to restrict the usage of a service provided via a network includes an authorization processing unit, a verification processing unit, a determination unit, and a restriction unit. The authorization processing unit issues authorization information in response to an authorization operation performed to permit a user to delegate authority to use the service to a client. The verification processing unit verifies the authorization information to be transmitted when the client having acquired the authorization information issued by the authorization processing unit uses the service, and permits the client to use the service with the user authority based on a result of the verification. The determination unit determines whether the number of uses of a mathematical function called by the client to use the service is greater than an upper limit. The restriction unit restricts the usage of the mathematical function if the determination unit determines that the number of uses is greater than the upper limit. The determination unit is configured to determine whether the number of uses of the mathematical function called by the client to use the service is greater than the upper limit when the authorization information is issued by the authorization processing unit and when the authorization information is verified by the verification processing unit.

The authorization server system according to the present invention assures a client of appropriate API usage in a case where the client acquires delegation of authority from a user and accesses a cooperation target server.

Further features of the present invention will become apparent from the following description of exemplary embodiments with reference to the attached drawings.

### BRIEF DESCRIPTION OF THE DRAWINGS

FIG. 1 illustrates a system configuration.

FIG. 2 illustrates a hardware configuration of each apparatus.

FIGS. 3A, 3B, and 3C illustrate software module configurations of respective apparatuses.

FIGS. 4A, 4B, and 4C illustrate table structures that are managed by an authorization server.

FIGS. 5A, 5B, 5C, and 5D illustrate table structures that are managed by the authorization server.

FIGS. 6A, 6B, and 6C illustrate examples of an API upper-limit management screen.

FIG. 7 (consisting of FIGS. 7A and 7B) illustrates an API usage sequence.

FIGS. 8A, 8B, and 8C illustrate screen examples.

FIG. 9 illustrates an API upper-limit verification processing flow.

FIG. 10 illustrates an API ordinary upper-limit verification processing flow.

FIG. 11 illustrates an API individual upper-limit verification processing flow.

FIG. 12 illustrates a table structure that is managed by the authorization server according to a second exemplary embodiment.

FIG. 13 illustrates an example of the API upper-limit management screen according to the second exemplary embodiment.

FIG. 14 illustrates an API upper-limit verification processing flow according to the second exemplary embodiment.

### DESCRIPTION OF THE EMBODIMENTS

A cloud service according to an exemplary embodiment of the present invention has a multi-tenant architecture. The multi-tenant architecture is characterized by providing the same web application deployed by a common server to a plurality of corporations or organizations. In this respect, the multi-tenant architecture is advantageous in cost performance because it is unnecessary to prepare and provide a dedicated server for each service providing destination (e.g., a corporation or an organization).

It is now presumed that the above-mentioned service A has the multi-tenant architecture and is available to users belonging to a plurality of tenants (e.g., tenant 1 and tenant 2). Further, it is presumed that the above-mentioned service B is a client of the service A and therefore the service B can use an API of the service A that is opened to the public. As described above, the usage of the API by the client is restricted by the upper limit determined beforehand with respect to the number of uses per unit time. In this case, the following problem may occur.

If the service B uses the API based on an authorization token issued with authority delegated by a user belonging to the tenant 1 and the number of API uses has reached the upper limit, the API usage based on an authorization token issued with authority delegated by a user belonging to the tenant 2 is refused. More specifically, because of inadequacy of the SLA, the contents included in the SLA may not be guaranteed for the user belonging to the tenant 2. The above-mentioned problem occurs when the upper limit is not set for each tenant with respect to the usage of the API. The authorization server system according to the present exemplary embodiment has a novel configuration effective to the above-mentioned cloud service.

The following is the definition of each language used in the exemplary embodiments of the present invention. First, the service is a function to be provided to each client when a software program that runs on a server is executed according to a request from the client. In this respect, a web application (software) may be referred to as an independent service. In the present exemplary embodiment, two types of services are usable. One of them is a cloud service that can be provided by a cooperation server. The other service can be provided by a resource server. In the following description, it is presumed that a user is accessing the service provided by the cooperation server via a terminal. Further, the resource server opens an API of the service to the public. The cooperation server can use the API to provide a mashup function to each user. More specifically, the cooperation server is a client when it is seen from the resource server.

To use the API of the resource server, the cooperation server requires delegation of authority based on a user authorization operation according to the Authorization Code Grant of the OAuth 2.0 described below. In other words, the cooperation server can use the API of the resource server only when the cooperation server acquires delegation of authority from a user. Further, to secure the quality of a service provided by the resource server, the number of API uses per unit time by the cooperation server (i.e., a client) is managed. If the resource server is simply configured to count the number of API uses and verify whether the count number has reached an upper limit, the resource server cannot reduce its load when the cooperation server excessively accesses the API. To solve the above-mentioned problem, the authorization server system according to the present exemplary embodiment can reduce the load of the resource server by cooperating with an authorization server in such a way as to restrict the delegation of authority according to the OAuth 2.0, as described in detail below.

API is a mathematical function to be called when a service is used. Each client (i.e., a calling source) can receive the service by calling the API. It can be seen from the user as if the client has performed the processing. Hereinafter, the present exemplary embodiment is described in detail below with reference to the drawings.

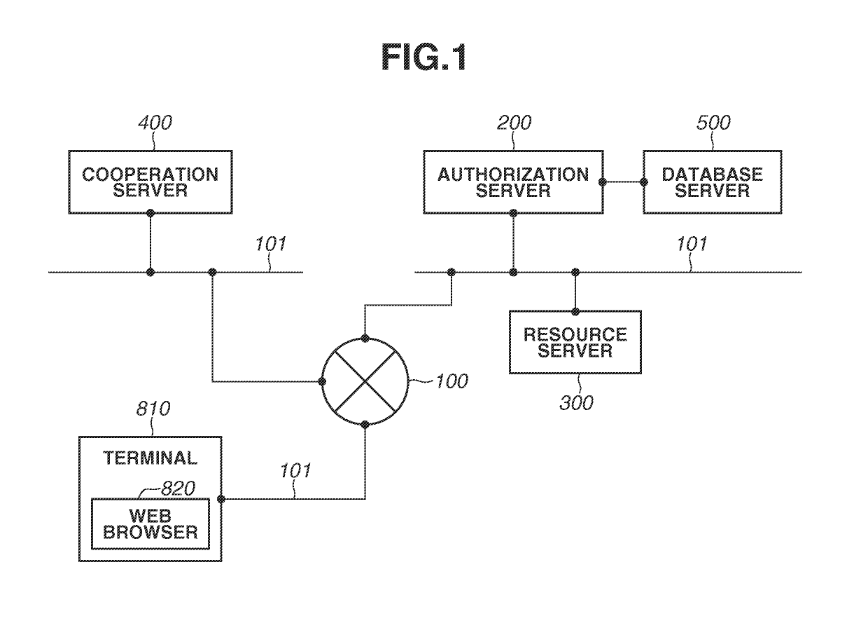

An authority delegation system according to the present exemplary embodiment can be realized as a network system having a configuration illustrated in FIG. 1. The authority delegation system includes a wide area network (i.e., WAN) 100 and a local area network (i.e., LAN) 101. In the present exemplary embodiment, the WAN 100 constitute a World Wide Web (WWW) system. Constituent components of the system are connected via the LAN 101.

An authorization server 200 can realize the OAuth 2.0 and includes an authorization server module installed thereon. A resource server 300 includes a resource server module installed thereon. The resource server module includes an API, which is opened as a web service to the public. A cooperation server 400 includes a cooperation server module installed thereon. The cooperation server module can use the API opened by the resource server module included in the resource server 300 to enable a user to use a mashup function in addition to its own services. A database server 500 is connected to the authorization server 200 via the LAN 101. The database server 500 stores data that can be used by the authorization server module. A terminal 810 includes a web browser 820 installed thereon. For example, the terminal 810 is a personal computer (PC) or a portable terminal (e.g., a smartphone).

A user can use the web browser 820 to communicate with the cooperation server 400 and the authorization server 200. Further, the authorization server 200 and the resource server 300 are connected to each other via the LAN 101. Further, the authorization server 200, the resource server 300, the cooperation server 400, and the terminal 810 can communicate with each other via the WAN 100. Further, the authorization server 200 and the database server 500 can be configured as a single server. Although each server according to the present exemplary embodiment is constituted as a single apparatus, a server group composed of a plurality of devices can constitute each server. In view of the foregoing, each server according to the present exemplary embodiment is referred to as a server system. For example, an authorization server system can be constituted by a single authorization server or can be constituted by an authorization server group including a plurality of authorization servers.

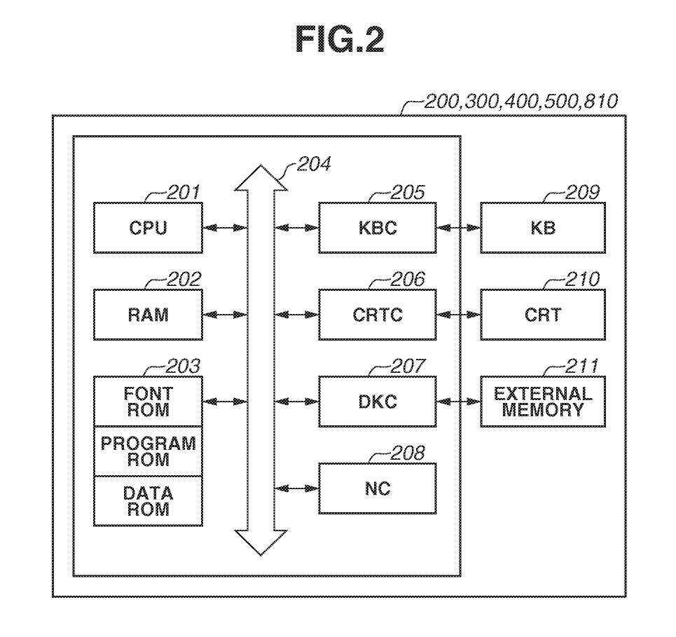

The authority delegation system according to the present exemplary embodiment can be realized as a system composed of servers and a terminal, each having a configuration illustrated in FIG. 2. FIG. 2 illustrates a hardware configuration applicable to each of the authorization server 200, the resource server 300, the cooperation server 400, the terminal 810, and the database server 500. The hardware block diagram illustrated in FIG. 2 corresponds to a hardware block diagram of a general information processing apparatus. A hardware configuration of a general information processing apparatus is applicable to each server (or the terminal) according to the present exemplary embodiment.

In FIG. 2, a central processing unit (CPU) 201 can execute a program (e.g., an operating system (OS) or an application), which is stored in a program ROM of the ROM 203 or loaded into a random access memory (RAM) 202 from an external memory 211, such as a hard disk (HD), to control each block connected to a system bus 204. Executing the program can realize processing of each sequence described in detail below. The RAM 202 is functionally operable as a main memory or a work area for the CPU 201. A keyboard controller (KBC) 205 can control each key input from a keyboard 209 or a pointing device (not illustrated). A CRT controller (CRTC) 206 can control a display operation to be performed by a CRT display device 210. A disk controller (DKC) 207 can control a data access to the external memory 211, such as the hard disk (HD), which can store various data. A network controller (NC) 208 can perform communication control processing for other devices that are accessible via the WAN 100 or the LAN 101. In the following description, unless otherwise noted, the CPU 201 serves as a main hardware component of each server or the terminal. On the other hand, an application program installed on the external memory 211 serves as a main software component of each server or the terminal.

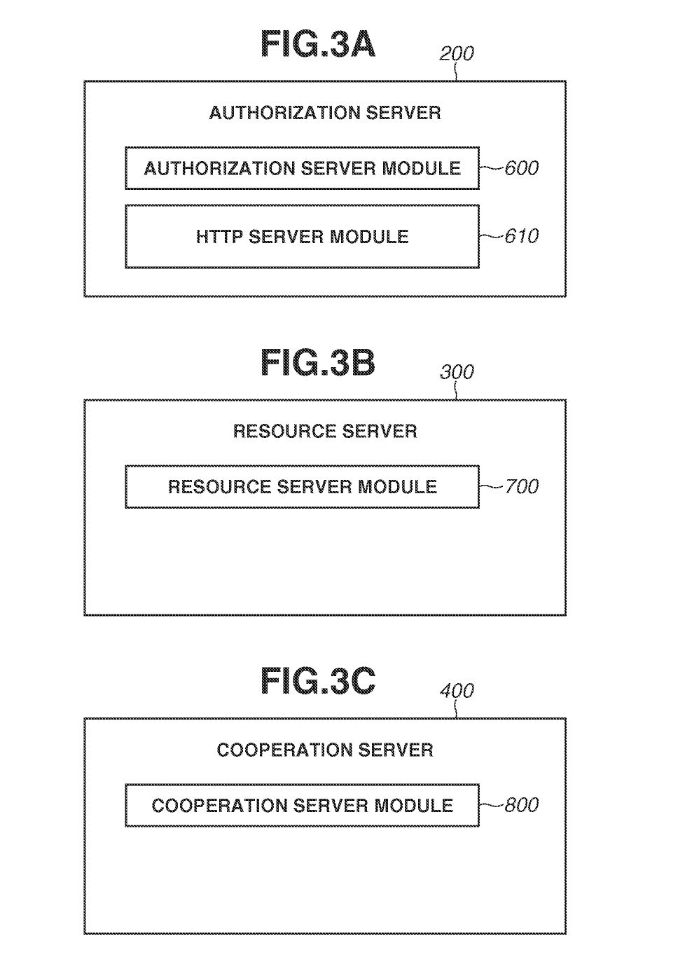

FIG. 3A illustrates a module configuration of the authorization server 200. FIG. 3B illustrates a module configuration of the resource server 300. FIG. 3C illustrates a module configuration of the cooperation server 400. The authorization server 200, the resource server 300, and the cooperation server 400 are identical to those illustrated in FIG. 2. In FIG. 3A, the authorization server 200 includes an authorization server module 600 and an HTTP server module 610. The HTTP server module 610 is a module capable of performing HTTP communications with the web browser 820 installed on the terminal 810 accessible via the WAN 100. Further, the HTTP server module 610 can perform SSL/TLS based communications and includes a certificate store (not illustrated). Further, in the present exemplary embodiment, if an authorization request is accepted as described below, the HTTP server module 610 requests a request source to perform user authentication based on user ID and password.

Next, the authorization server module 600 accepts a request from the web browser 820 via the HTTP server module 610, processes the request, and transmits a response to the web browser 820. In this case, in the present exemplary embodiment, the HTTP server module 610 accepts the user authentication and, if the request source has been successfully authenticated, the HTTP server module 610 generates an authentication token linked to authenticated user information and notifies the authorization server module 600 of the generated authentication token. In the present exemplary embodiment, the authentication token is a token indicating that an authenticated user is currently in a log-in state or a token verifying whether the user authentication has been completed. It is feasible to identify each user by using the authentication token.

On the other hand, an authorization token described below is a token indicating that a target client is permitted to access with user authority, instead of the user, when an authenticated user has performed an authorization operation. In this respect, the authorization token is different from the authentication token. Further, the authorization token is a token indicating that the client has authority to use the API, which can be acquired using an authorization code. The authorization token, i.e., information indicating that the authority to use a user service is delegated to the client, is referred to as authorization information.

Processing that can be performed by the HTTP server module 610 and the authorization server module 600 is described in detail below. The authorization server module 600 is configured to accept authorization token verification processing from a resource server module 700 via the LAN 101, perform the authorization token verification processing, and return a response to the resource server module 700. The authorization token verification processing can be configured as Remote Procedure Call (RPC), or can be configured as API of a web service that can perform communications via the HTTP server module 610 in the LAN 101.

The resource server 300 illustrated in FIG. 3B includes the resource server module 700. The resource server module 700 can be configured to operate on an HTTP server module (not illustrated). The resource server module 700 includes an API that is opened to the public as a web service. The resource server module 700 can accept a resource request from the cooperation server 400 as described below, process the resource request, and return a response to the cooperation server 400. Further, via the LAN 101, the resource server module 700 can request the authorization server module 600 to perform authorization token verification processing as described below.

The cooperation server 400 illustrated in FIG. 3C includes a cooperation server module 800. The cooperation server module 800 can be configured to operate on an HTTP server module (not illustrated). The cooperation server module 800 is a web application that can accept a request from the web browser 820, process the request, and return a response to the web browser 820. Further, the cooperation server module 800 can be configured as an HTTP client that can call an API of a web service that is opened to the public by the resource server module 700.

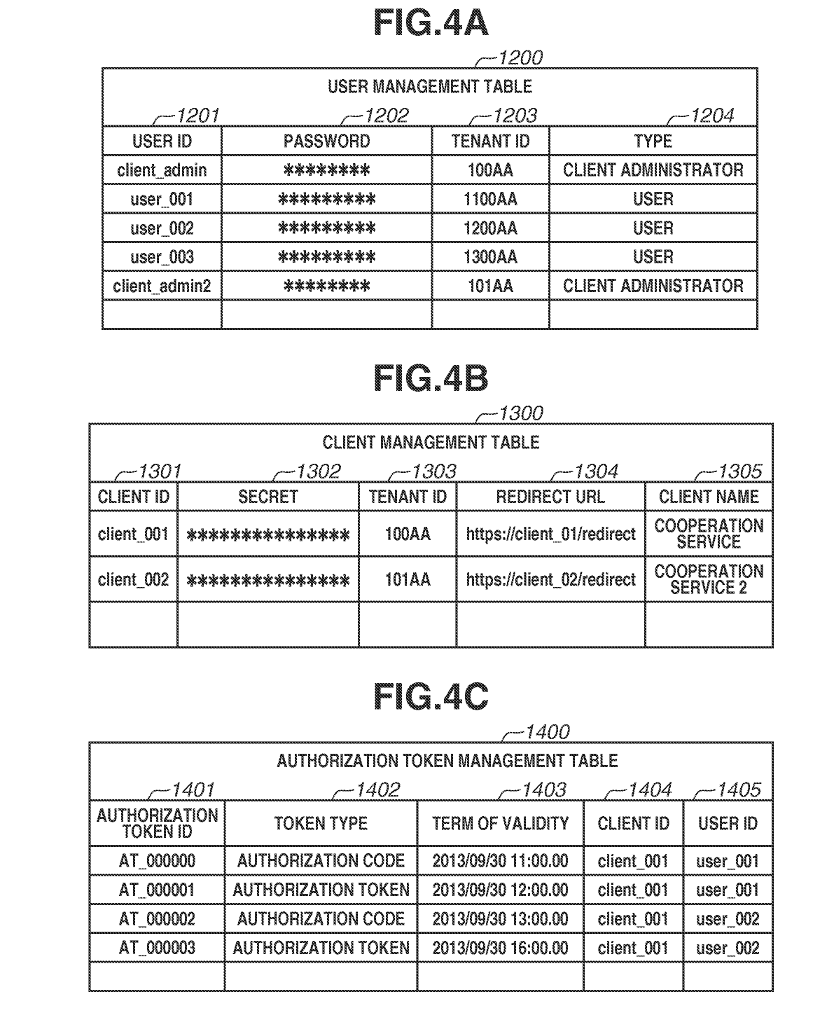

FIGS. 4A, 4B, and 4C illustrate data tables that are stored in an external memory (not illustrated) of the database server 500 with which the authorization server 200 can communicate via the LAN 101. Alternatively, the data tables illustrated in FIGS. 4A, 4B, and 4C can be stored in the external memory of the authorization server 200. FIG. 4A illustrates a user management table 1200. The user management table 1200 is composed of data columns for user ID 1201, password 1202, tenant ID 1203, and type 1204. The authorization server 200 has a function of authenticating each user by verifying information about a set of the user ID 1201 and the password 1202 and then, if the verification result is true, generating authentication information.

The tenant ID 1203 is ID information about a tenant to which a user identified by each user ID belongs. The tenant is a unit referable to identify a corporation to which each user belongs. The corporation to which the user belongs can be identified based on the tenant ID. The example used in the present exemplary embodiment is not limited to the above-mentioned tenant. The tenant can be replaced by another specific group to manage each user. In this case, it is feasible to identify a group to which the user belongs based on a group ID. The type 1204 indicates user authority identified by each user ID. If the type 1204 is “client administrator”, it is feasible to confirm and set a client API upper-limit number on an API upper-limit management screen described below. The user ID 1201 and the password 1202 corresponding to the type 1204 of “client administrator” are notified beforehand to a user who manages the cooperation server 400 or to a user to whom management is delegated. Further, if the type 1204 is “user”, it is feasible to delegate authority to the client according to a sequence described below. The user ID 1201 and the password 1202 corresponding to the type 1204 of “user” are notified beforehand to a user of the terminal 810. Each processing is described in detail below.

FIG. 4B illustrates a client management table 1300. The client management table 1300 is composed of data columns for client ID 1301, secret 1302, tenant ID 1303, redirect URL 1304, and client name 1305. The authorization server 200 has a function of authenticating each client by verifying information about a set of the client ID 1301 and the secret 1302 and then, if the verification result is true, generating authentication information. Further, the set of the client ID 1301 and the secret 1302 is set beforehand in the cooperation server module 800. In the present exemplary embodiment, the redirect URL is URL information about a client to be referred to in the Authorization Code Grant flow of the OAuth 2.0 described below, when the client receives the authorization code indicating that the authorization server 200 has permitted the user to delegate authority to the client. In the present exemplary embodiment, the redirect URL is URL of the cooperation server module 800 to be referred to when the cooperation server module 800 accepts the authorization code issued by the authorization server module 600. The redirect URL 1304 and the client name 1305 can be acquired and registered when the client ID 1301 and the secret 1302 are generated. In the present exemplary embodiment, the client ID 1301, the secret 1302, the redirect URL 1304, and the client name 1305 can be transmitted and received between a provider that deploys a cloud service using the cooperation server 400 and a provider that deploys a cloud service using the authorization server 200 according to an agreement determined beforehand.

However, for example, the authorization server module 600 can be configured to include a client issuance screen to enable an administrator of the cooperation server 400 to access the above-mentioned screen to transmit and receive information. The tenant ID 1303 is related with the tenant ID 1203 of the user management table 1200. If the tenant ID 1303 is identical to tenant ID 1203, it can be identified that the client identified by the client ID is a “client administrator” user. More specifically, the “client administrator” user of the same tenant ID can perform confirmation and setting with respect to the client API upper-limit number identified by the client ID. Processing relating to the redirect URL 1304 and the client name 1305 is described in detail below.

FIG. 4C illustrates an authorization token management table 1400. The authorization token management table 1400 is composed of data columns for authorization token ID 1401, token type 1402, term of validity 1403, client ID 1404, and user ID 1405. The authorization token management table 1400 is described in detail below.

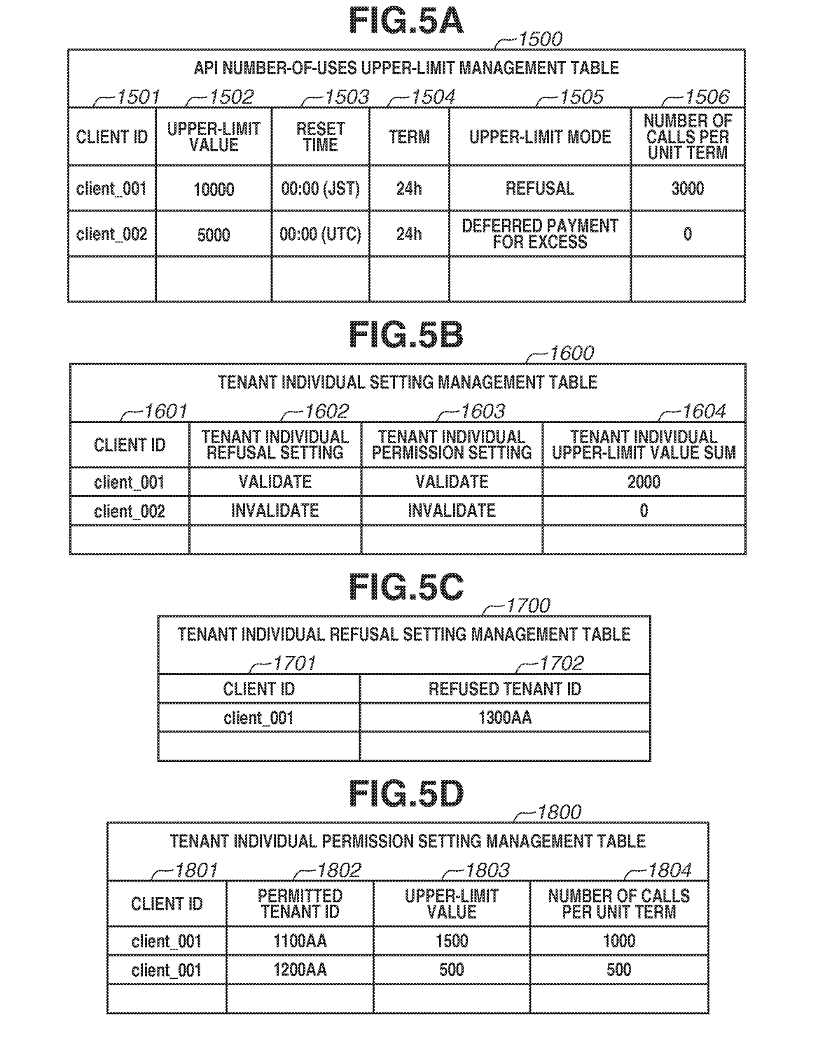

The data tables illustrated in FIGS. 5A, 5B, 5C, and 5D can be stored in the external memory of the database server 500 with which the authorization server 200 can communicate via the LAN 101. Alternatively, the above-mentioned data tables can be stored in the external memory of the authorization server 200.

FIG. 5A illustrates an API number-of-uses upper-limit management table 1500. The API number-of-uses upper-limit management table 1500 is composed of data columns for client ID 1501, upper-limit value 1502, reset time 1503, term 1504, upper-limit mode 1505, and number of calls per unit term 1506. In the present exemplary embodiment, setting values of the upper-limit value 1502, the reset time 1503, and the term 1504 are set beforehand between the provider that deploys the cloud service using the cooperation server 400 and a provider that deploys a cloud service using the resource server 300 according to an agreement determined beforehand. In the present exemplary embodiment, the authorization server module 600 can include a management screen (not illustrated) dedicated to manage the contract between providers and can be configured to enable an administrator of the cooperation server 400 to access the above-mentioned screen via the web browser 820 and perform settings. The API number-of-uses upper-limit management table 1500 is described in detail below. Further, the number-of-calls per unit term 1506 can be reset to 0 at the reset time 1503 for each interval defined by the term 1504.

FIG. 5B illustrates a tenant individual setting management table 1600. The tenant individual setting management table 1600 is composed of data columns for client ID 1601, tenant individual refusal setting 1602, tenant individual permission setting 1603, and tenant individual upper-limit value sum 1604. The tenant individual setting management table 1600 is described in detail below.

FIG. 5C illustrates a tenant individual refusal setting management table 1700. The tenant individual refusal setting management table 1700 is composed of data columns for client ID 1701 and refused tenant ID 1702. The tenant individual refusal setting management table 1700 is described in detail below.

FIG. 5D illustrates a tenant individual permission setting management table 1800. The tenant individual permission setting management table 1800 is composed of data columns for client ID 1801, permitted tenant ID 1802, upper-limit value 1803, and number of calls per unit term 1804. The permitted tenant ID 1802 and the upper-limit value 1803 are registered in association with each other. If a permitted tenant ID is identified, an upper-limit value allocated to the tenant can be identified. The upper-limit value can be set for each group ID, i.e., for each tenant ID. The tenant individual permission setting management table 1800 is described in detail below. Further, the number-of-calls per unit term 1804 can be reset to 0 at the reset time 1503 for each interval defined by the term 1504 of the API number-of-uses upper-limit management table 1500.

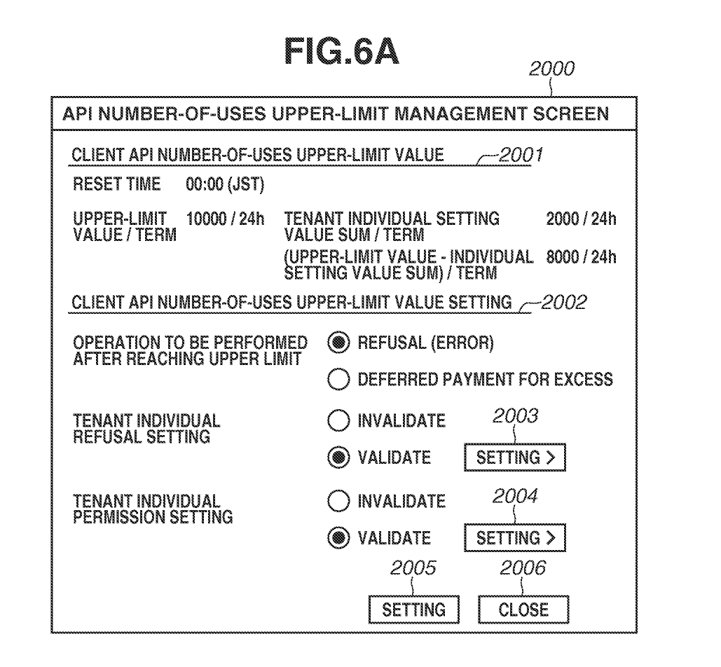

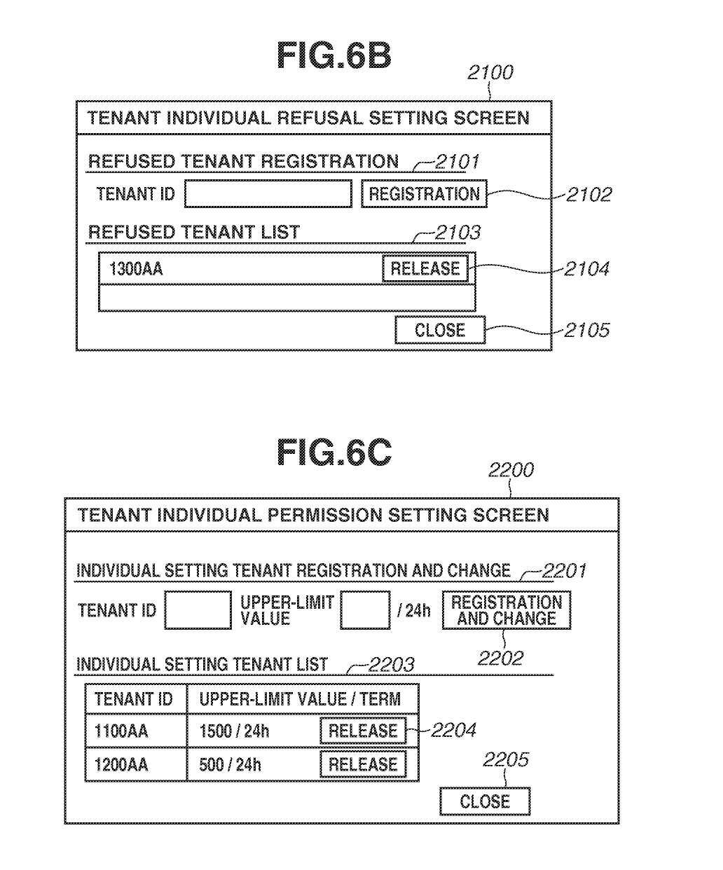

FIGS. 6A, 6B, and 6C illustrate examples of upper-limit management screens that can be generated by the authorization server module 600 to manage and set the client API upper-limit number. The screens illustrated in FIGS. 6A, 6B, and 6C can be displayed on the web browser 820 that is available for an administrator of the cooperation server 400 or a management delegated user.

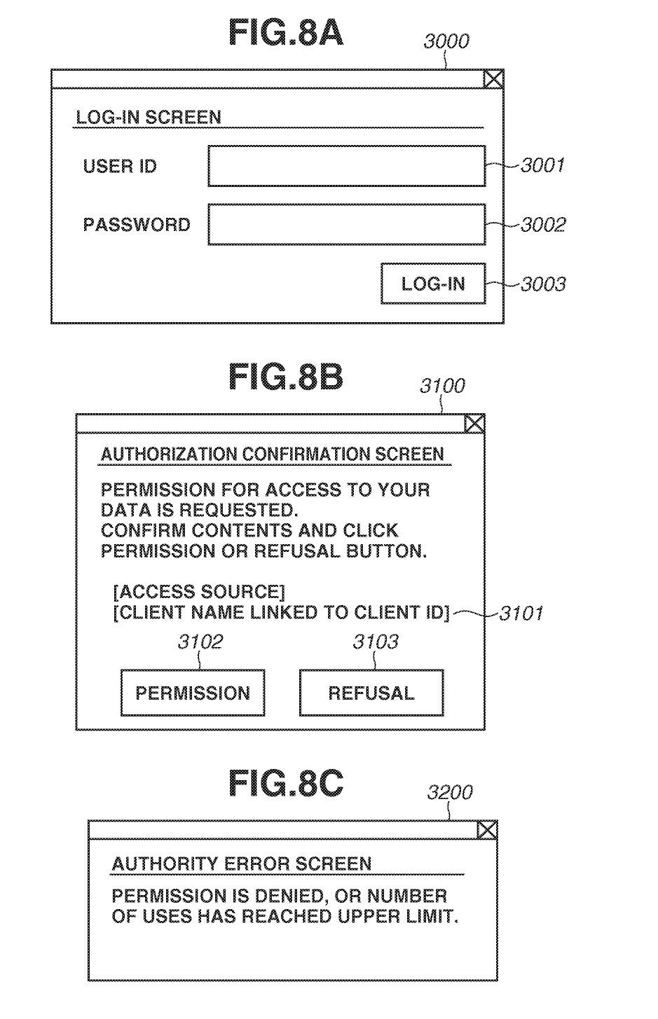

FIG. 6A illustrates an API number-of-uses upper-limit management screen 2000 used for confirming and setting the client API upper-limit number. The API number-of-uses upper-limit management screen 2000 includes setting fields for upper-limit value 2001, upper-limit value setting 2002, tenant individual refusal setting button 2003, tenant individual permission setting button 2004, setting button 2005, and closure button 2006. Hereinafter, processing relating to the API number-of-uses upper-limit management screen 2000 is described in detail below with reference to FIGS. 6A and 8A. If the closure button 2006 is pressed, the web browser 820 closes the above-mentioned screen and terminates the processing.

An administrator or a management delegated user of the cooperation server 400 launches the web browser 820 to access the HTTP server module 610. In response to the access from the web browser 820, the HTTP server module 610 verifies whether the notification from the web browser 820 includes an authentication token that is valid as an HTTP Cookie. If a valid authentication token is included, the HTTP server module 610 notifies the authorization server module 600 of the authentication token. If there is not any valid authentication token included in the notification, the HTTP server module 610 performs the following processing. The HTTP server module 610 transmits a response including a log-in screen usable for user authentication to the web browser 820. FIG. 8A is an example of the log-in screen included in the response from the HTTP server module 610. In the present exemplary embodiment, the user inputs a user ID and a password. If the input set of user ID and password coincides with information set registered in the user management table 1200, the user authentication is successfully completed. As another user authentication method, X.509 certificate or multi-stage authentication requiring a plurality of password input operations is employable. In this respect, the user authentication method is not limited to the above-mentioned example.

The log-in screen illustrated in FIG. 8A is composed of a user ID input field 3001 for the entry of a user ID, a password input field 3002 for the entry of a password, and a log-in button 3003 operable to perform a log-in operation. The user inputs log-in information via the screen illustrated in FIG. 8A, which can be displayed on the web browser 820, and presses the log-in button 3003. The web browser 820 transmits the input information to the HTTP server module 610. The HTTP server module 610 acquires the user ID and the password. Then, the HTTP server module 610 authenticates the user by verifying whether acquired information with information set of the user ID 1201 and the password 1202 in the user management table 1200. Further, the HTTP server module 610 confirms whether the type 1204 of the authenticated user ID 1202 is “client administrator” with reference to the user management table 1200. If the user authentication has been failed (more specifically, if the acquired information is not registered in the user management table 1200), or if the type 1204 is not “client administrator”, the HTTP server module 610 transmits a response including an authentication error screen (not illustrated) to the web browser 820. If the user authentication has been successfully completed, the HTTP server module 610 generates an authentication token.

The authentication token can be stored in the nonvolatile memory of the HTTP server module 610 in association with the user ID 1201 and the tenant ID 1203. Then, the HTTP server module 610 notifies the authorization server module 600 of the authentication token. In this case, the authentication token is set as an HTTP Cookie and can be set in the response, and notified from the HTTP server module 610 to the web browser 820. In other words, when the web browser 820 transmits the authentication token to the HTTP server module 610, the user can access the authorization server module 600 via the web browser 820 without inputting the user ID and the password. Hereinafter, as mentioned above, in the access from the web browser 820 to the authorization server module 600, the HTTP server module 610 performs authentication token verification and authentication processing and notifies the authentication token to the authorization server module 600, although redundant description thereof will be avoided. Note that the authentication token in this case is different from an authorization code and an authorization token described in detail below.

When the authorization server module 600 accepts the authentication token, the authorization server module 600 acquires a value of the tenant ID 1203 linked to the authentication token and identifies the client ID 1301 if the same tenant ID is set in the tenant ID 1303 of the client management table 1300. Then, the authorization server module 600 generates the API number-of-uses upper-limit management screen 2000 (i.e., the screen usable to confirm and set the API upper-limit number corresponding to the identified client ID), and transmits a response including the generated API number-of-uses upper-limit management screen 2000 to the web browser 820. Hereinafter, the authorization server module 600 performs client ID identification processing using the notified authentication token although redundant description thereof will be avoided.

The authorization server module 600 performs processing for generating the API number-of-uses upper-limit management screen 2000, as described in detail below. The authorization server module 600 acquires information about each item, if the identified client ID is set in the client ID 1501, from the API number-of-uses upper-limit management table 1500. The authorization server module 600 generates the upper-limit value 2001 based on the acquired upper-limit value 1502, the reset time 1503, and the term 1504. Further, the authorization server module 600 acquires information about each item, if the identified client ID is set in the client ID 1601, from the tenant individual setting management table 1600. The authorization server module 600 generates the upper-limit value 2001 and upper-limit value setting 2002 with reference to the acquired tenant individual refusal setting 1602, the tenant individual permission setting 1603, and the tenant individual upper-limit value sum 1604. The API number-of-uses upper-limit management screen 2000 illustrated in FIG. 6A is a screen example in a case where the identified client ID is “client_{—}001”.

Next, operations to be performed when various buttons are pressed on the API number-of-uses upper-limit management screen 2000 are described in detail below. The tenant individual refusal setting button 2003 is a button that is operable only when the option selected in the tenant individual refusal setting is “validate”. When the tenant individual refusal setting button 2003 is pressed, the authorization server module 600 generates a tenant individual refusal setting screen 2100 illustrated in FIG. 6B, and transmits a response including the generated tenant individual refusal setting screen 2100. The tenant individual refusal setting screen 2100 is described in detail below. The tenant individual permission setting button 2004 is a button that is operable only when the option selected in the tenant individual permission setting is “validate”. When the tenant individual permission setting button 2004 is pressed, the authorization server module 600 generates a tenant individual permission setting screen 2200 illustrated in FIG. 6C, and transmits a response including the generated tenant individual permission setting screen 2200. The tenant individual permission setting screen 2200 is described in detail below. The setting button 2005 is a button that is operable to set and reflect the selection state of each item on the tenant individual permission setting screen 2200. If the setting button 2005 is pressed, selection states of respective setting items, i.e., operation to be performed after reaching the upper limit, tenant individual refusal setting, and tenant individual permission setting, are notified from the web browser 820 to the authorization server module 600.

In response to the notification, the authorization server module 600 reflects the notified selection state of the operation to be performed after reaching the upper limit to the upper-limit mode 1505 of the client upper-limit management table 1500 with reference to the identified client ID. Further, the authorization server module 600 reflects the selection state of the tenant individual refusal setting to the tenant individual refusal setting 1602 of the tenant individual setting management table 1600 with reference to the identified client ID. Then, the authorization server module 600 reflects the selection state of the tenant individual permission setting to the tenant individual permission setting 1603. The authorization server module 600 transmits a response including the API number-of-uses upper-limit management screen 2000 to the web browser 820 based on each reflected data.

FIG. 6B illustrates the tenant individual refusal setting screen 2100. The tenant individual refusal setting screen 2100 includes setting fields for refused tenant registration 2101, registration button 2102, refused tenant list 2103, release button 2104, and closure button 2105. Hereinafter, processing relating to the tenant individual refusal setting screen 2100 is described in detail below with reference to FIG. 6B. If the closure button 2105 is pressed, the web browser 820 closes the above-mentioned screen and terminates the processing.

If the tenant individual refusal setting button 2003 is pressed on the API number-of-uses upper-limit management screen 2000, the authorization server module 600 acquires no or at least one piece of information based on the identified client ID from the tenant individual refusal setting table 1700 with respect to the refused tenant ID 1702. Then, the authorization server module 600 generates the tenant individual refusal setting screen 2100. The registration button 2102 is a button that is operable to additionally register a refusing tenant. When the registration button 2102 is pressed, the web browser 820 notifies the authorization server module 600 of the tenant ID input in the refused tenant registration 2101. In response to the notification, the authorization server module 600 sets the identified client ID and the notified tenant ID in the tenant individual refusal setting table 1700. The release button 2104 is a button that is operable to release a refusing tenant. When the release button 2104 is pressed, the web browser 820 notifies the authorization server module 600 of the tenant ID displayed in the refused tenant list 2103 corresponding to the release button 2104. In response to the notification, the authorization server module 600 deletes the set of the identified client ID and the notified tenant ID from the tenant individual refusal setting table 1700. The tenant individual refusal setting screen 2100 illustrated in FIG. 6B is a screen example in a case where the identified client ID is “client_{—}001”.

FIG. 6C illustrates an example of the tenant individual permission setting screen 2200. The tenant individual permission setting screen 2200 is composed of setting fields for individual setting tenant registration and change 2201, registration and change button 2202, individual setting tenant list 2203, release button 2204, and closure button 2205. Hereinafter, processing relating to the tenant individual permission setting screen 2200 is described in detail below with reference to FIG. 6C. When the close button 2205 is pressed, the web browser 820 closes the above-mentioned screen and terminates the processing.

If the tenant individual permission setting button 2004 is pressed on the API number-of-uses upper-limit management screen 2000, the authorization server module 600 acquires no or at least one piece of information of the permitted tenant ID 1802 and the upper-limit value 1803 based on the identified client ID from the tenant individual permission setting table 1800, and of the term 1504 from the client upper-limit management table 1500. Further, the authorization server module 600 generates the tenant individual permission setting screen 2100 based on the acquired information. The registration and change button 2202 is a button that is operable to add and register an individual setting tenant or change the upper-limit value. When the registration and change button 2202 is pressed, the web browser 820 notifies the authorization server module 600 of the entry of tenant ID and upper-limit value in the individual setting tenant registration and change 2201. In response to the notification, the authorization server module 600 sets the identified client ID, the notified tenant ID, and the upper-limit value to the tenant individual permission setting table 1800. In this case, if the notified set of client ID and tenant ID is already set, the authorization server module 600 updates the upper-limit value 1803 corresponding to the notified set. Further, the authorization server module 600 recalculates and updates the tenant individual upper-limit value sum 1604 in the tenant individual setting management table 1600. The release button 2204 is a button that is operable to release an individual setting tenant. If the release button 2204 is pressed, the web browser 820 notifies the authorization server module 600 of the tenant ID displayed on the individual setting tenant list 2203 corresponding to the release button 2204. In response to the notification, the authorization server module 600 deletes the identified set of client ID and tenant ID and the upper-limit value from the tenant individual permission setting table 1800. The tenant individual permission setting screen 2200 illustrated in FIG. 6C is a screen example in a case where the identified client ID is “client_{—}001”.

Although the screens illustrated in FIGS. 6A, 6B, and 6C are provided as independent screens, all of the illustrated screens may be united as a single screen. Further, although both of the tenant individual permission setting and the tenant individual refusal setting are settable in the screen of FIG. 6A, the screen may be configured to allow at least one of the above-mentioned settings. In the present exemplary embodiment, the screen that enables designating a tenant ID and setting an upper-limit value when a mathematical function is called for the designated tenant ID is referred to as “management screen”. The management screen enables a user to perform the settings illustrated in FIGS. 6A, 6B, and 6C.

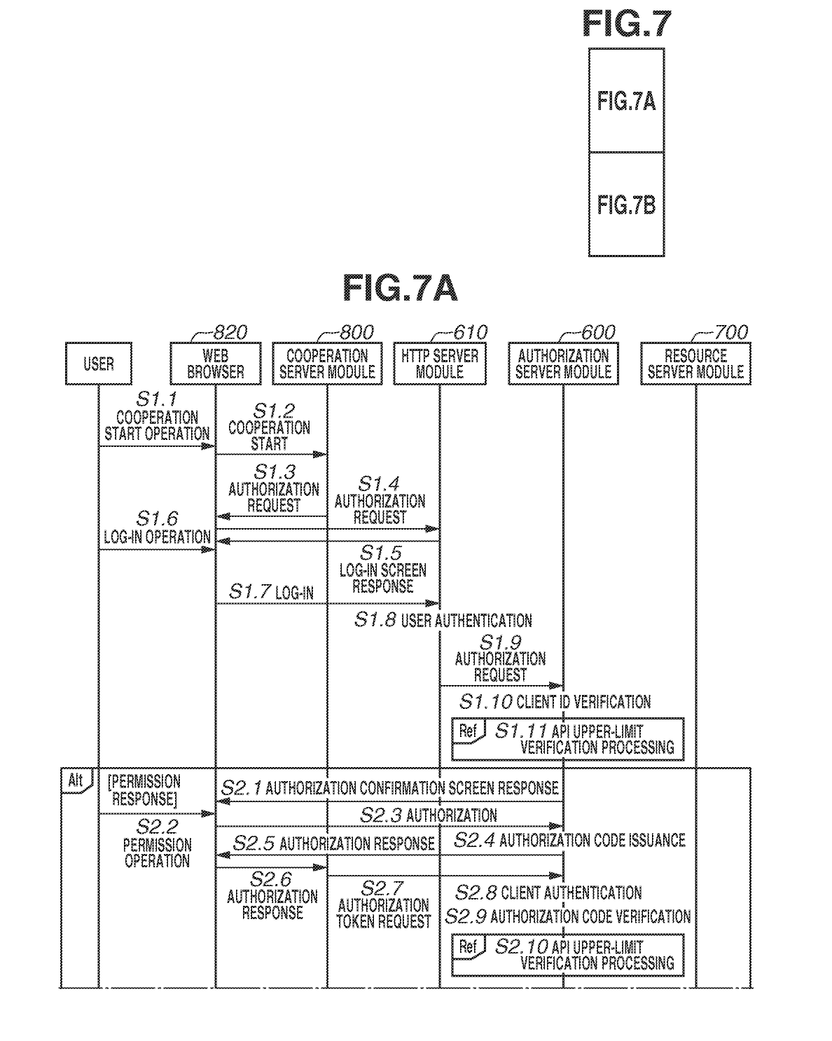

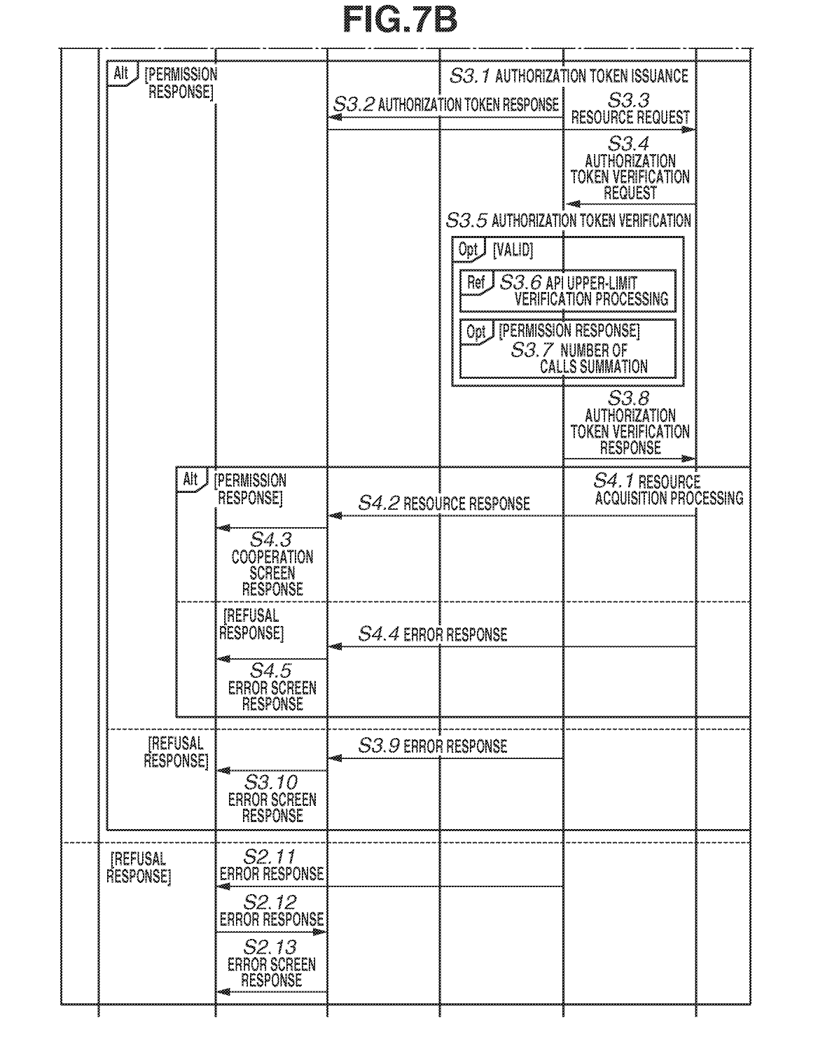

Next, an example processing sequence according to the present exemplary embodiment, in which the cooperation server module 800 uses the API opened to the public by the resource server module 700, is described in detail below with reference to FIG. 7 and FIGS. 8A, 8B, and 8C. In FIG. 7, “Ref” stands for “reference” that is described with reference to another drawing. Further, “Alt” stands for “branch” that is branch processing to be performed based on a result of the sequence performed in advance. Further, “Opt” indicates that the processing is performed only when the upper limit is satisfied.

In step S1.1, a user performs a cooperation start operation displayed on the web browser 820, although not illustrated. In step S1.2, the web browser 820 transmits a cooperation start notification to the cooperation server module 800. In step S1.3, in response to the cooperation start notification, the cooperation server module 800 transmits an authorization request to the web browser 820. In step S1.4, the web browser 820 transmits an authorization request to the authorization server module 600 via the HTTP server module 610. In the present exemplary embodiment, authorization token issuance processing including the authorization request in step S1.3 and authorization token response in step S3.2 can be performed according to the Authorization Code Grant flow defined by the OAuth 2.0.

In the present exemplary embodiment, the authorization request includes at least the client ID and the redirect URL held by the cooperation server module 800. Further, the authorization request includes an issuance request of an authorization code necessary for the cooperation server module 800 to access the resource server module 700 with authority delegated by the user. As described above, the redirect URL is URL information about a client to be referred to for accepting the authorization code issued by the authorization server 200.

In step S1.4, the HTTP server module 610 accepts the authorization request from the web browser 820 and verifies whether the notification from the web browser 820 includes a valid authentication token as an HTTP Cookie. If the valid authentication token is included, the HTTP server module 610 notifies the authorization server module 600 of the authentication token. The operation proceeds to step S1.9. If the valid authentication token is not included, the HTTP server module 610 performs predetermined processing in step S1.5.

In step S1.5, the HTTP server module 610 transmits a response including a user authentication log-in screen to the web browser 820. FIG. 8A illustrates an example of the log-in screen transmitted from the HTTP server module 610. In the present exemplary embodiment, to perform authentication, the user is required to input a user ID and a password to check whether the input set of user ID and password coincides with information set registered beforehand in the user management table 1200. As another user authentication method, X.509 certificate or multi-stage authentication requiring a plurality of password input operations is employable. In this respect, the user authentication method is not limited to the above-mentioned example.

The log-in screen illustrated in FIG. 8A is composed of the user ID input field 3001 for the entry of a user ID, the password input field 3002 for the entry of a password, and the log-in button 3003 operable to perform a log-in operation. The user inputs necessary log-in information on the screen displayed on the web browser 820 and then presses the log-in button 3003. The web browser 820 transmits the input information to the HTTP server module 610. The HTTP server module 610 acquires the user ID and the password. Then, the HTTP server module 610 authenticates the user by verifying whether the acquired information coincides with information set of the user ID 1201 and the password 1202 in the user management table 1200. Further, the HTTP server module 610 confirms whether the type 1204 of the authenticated user ID 1202 is “user” with reference to the user management table 1200. If the user authentication has been failed (more specifically, if the acquired information is not registered in the user management table 1200), or if the type 1204 is not “user”, the HTTP server module 610 transmits a response including the authentication error screen (not illustrated) to the web browser 820.

If the user authentication has been successfully completed, the HTTP server module 610 generates an authentication token. The authentication token can be stored in the nonvolatile memory of the HTTP server module 610 in association with the user ID 1201 and the tenant ID 1203. Then, the HTTP server module 610 notifies the authorization server module 600 of the authentication token. In this case, the authentication token is set as an HTTP Cookie, is set in the response, and notified from the HTTP server module 610 to the web browser 820. Hereinafter, as mentioned above, in the access from the web browser 820 to the authorization server module 600, the HTTP server module 610 performs authentication token verification and authentication processing and notifies the authentication token to the authorization server module 600, although redundant description thereof will be avoided.

In step S1.9, if the authorization request including the authentication token is accepted, then in step S1.10, the authorization server module 600 verifies whether the acquired authorization request includes a correct set of client ID and redirect URL. More specifically, the authorization server module 600 verifies whether the set of client ID and redirect URL included in the acquired authorization request coincides with the set of the client ID 1301 and the redirect URL 1304 registered in the client management table 1300. If it is determined that the acquired set of client ID and redirect URL does not coincide with the registered set of the client ID 1301 and the redirect URL 1304, the authorization server module 600 transmits a response including an error screen (not illustrated) to the web browser 820 via the HTTP server module 610. If it is determined that the acquired set of client ID and redirect URL coincides with the registered set of the client ID 1301 and the redirect URL 1304, then in step S1.11, the authorization server module 600 performs API upper-limit verification processing. In this case, the authorization server module 600 performs processing using the user ID acquired from the authentication token notified from the HTTP server module 610 and the client ID acquired as the authorization request. The API upper-limit verification processing is described in detail below.

If the result of the API upper-limit verification processing is “refusal response”, then in step S2.11 and step S2.12, the authorization server module 600 transmits an authority error response to the cooperation server module 800 via the web browser 820. More specifically, the authorization server module 600 transmits a redirect response to the web browser 820 in such a way as to redirect the web browser 820 to the redirect URL acquired upon the authorization request. In step S2.13, the cooperation server module 800 transmits a response including an authority error screen illustrated in FIG. 8C to the web browser 820, and terminates the processing illustrated in FIG. 7. The screen illustrated in FIG. 8C is a mere example. For example, if the cooperation server module 800 can recognize the contents of an error response, a screen that displays only the authority related error contents and a screen notifying that the number of API uses has reached the upper limit may be selectively displayed. If the number of API uses has already reached the upper limit through the above-described sequential processing, the system can terminate the processing without requiring the cooperation server module 800 to access the resource server module 700. As a result, the load of the resource server module 700 can be reduced.

Next, if the result of the API upper-limit verification processing is “permission response”, then in step S2.1, the authorization server module 600 transmits a response including an authorization confirmation screen to the web browser 820. FIG. 8B illustrates an example of the authorization confirmation screen that is included in the response. An authorization confirmation screen 3100 includes an access source display area 3101, which is an area in which the client name 1305 acquired from the client management table 1300 with reference to the client ID included in the authorization request can be displayed. Further, the authorization confirmation screen 3100 includes a permission button 3102 and a refusal button 3103 that can be operated by a user to perform an authorization operation and a refusal operation with respect to the contents of the above-mentioned information. If the user presses the refusal button 3103, then in step S2.11 and step S2.12, the authorization server module 600 transmits an authority error response to the cooperation server module 800, similar to the operation performed when the result of the API upper-limit verification processing is “refusal response”. The authority error response can be configured to enable a user to arbitrarily modify the contents of the error response in such a way as to change the configuration or wording of the screen to be displayed by the cooperation server module 800 that accepts the response.

In step S2.2, the user presses the permission button 3102 on the authorization confirmation screen 3100. More specifically, if an authorization operation to permit delegating user authority to use a service provided by the resource server 300 to the cooperation server 400 is performed, then in step S2.3, the authorization is notified from the web browser 820 to the authorization server module 600.

In step S2.4, the authorization server module 600 issues an authorization code. More specifically, the authorization server module 600 issues an authorization token ID and registers the client ID included in the authorization request and the user ID of the user from whom the permission has been obtained to the authorization token management table 1400. In this case, the authorization server module 600 registers the authorization code as the token type 1402 and the authorization code valid date and time as the term of validity 1403. Then, in steps S2.5 and S2.6, the authorization server module 600 adds the authorization token ID of the issued authorization code and transmits an authorization response to the cooperation server module 800 via the web browser 820. More specifically, the authorization server module 600 transmits a redirect response to the web browser 820 in such a way as to redirect the web browser 820 to the redirect URL acquired upon the authorization request.

In step S2.7, the cooperation server module 800 transmits an authorization token request to the authorization server module 600. The authorization token request includes at least the acquired authorization code, the client ID, the secret, and the redirect URL transmitted upon the authorization request.

In step S2.8, the authorization server module 600 authenticates the client with reference to the acquired set of the client ID and the secret. More specifically, the authorization server module 600 authenticates the client by verifying whether the acquired set of the client ID and the secret coincides with the set of the client ID 1301 and the secret 1302 in the client management table 1300. In the present exemplary embodiment, if the client authentication has been failed, the authorization server module 600 transmits an authentication error response to the cooperation server module 800. If the client authentication has been successfully completed, then in step S2.9, the authorization server module 600 verifies the acquired authorization code. In the authorization code verification, the authorization server module 600 verifies whether the authorization token ID of the acquired authorization code is registered in the authorization token management table 1400. If the authorization token ID is registered, the authorization server module 600 verifies whether the authorization token ID is within the term of validity 1403. Further, the authorization server module 600 verifies whether the redirect URL acquired based on the authorization token request coincides with the redirect URL 1304 registered in the client management table 1300, with reference to the client ID 1404 linked to the authorization token ID. If the result of the authorization code verification is invalid, the authorization server module 600 transmits a token incorrect error response to the cooperation server module 800. If the result of the authorization code verification is valid, then in step S2.10, the authorization server module 600 performs API upper-limit verification processing. In this case, the authorization server module 600 performs the processing using the user ID linked to the authorization code and the authenticated client ID. The API upper-limit verification processing is described in detail below. If the result of the API upper-limit verification processing is “refusal response”, then in step S3.9, the authorization server module 600 transmits an authority error response to the cooperation server module 800. In step S3.10, the cooperation server module 800 transmits a response including the authority error screen illustrated in FIG. 8C to the web browser 820, and terminates the processing illustrated in FIG. 7.

If the number of API uses has already reached the upper limit through the above-described sequential processing, the system can terminate the processing without requiring the cooperation server module 800 to access the resource server module 700. As a result, the load of the resource server module 700 can be reduced.

Next, if it is determined that the result of the API upper-limit verification processing is “permission response”, then in step S3.1, the authorization server module 600 issues an authorization token. More specifically, the authorization server module 600 issues an authorization token ID, and registers the user ID and the authenticated client ID linked to the authorization code to the authorization token management table 1400. In this case, the authorization server module 600 registers the authorization token as the token type 1402 and the authorization token valid date and time as the term of validity 1403.

Then, in step S3.2, the authorization server module 600 transmits a response including the authorization token ID of the issued authorization token to the cooperation server module 800. In this case, the authorization server module 600 can be configured to transmit a response including the term of validity of the issued authorization token. In the present exemplary embodiment, the system does not issue any refresh token regulated by the OAuth 2.0 to update the authorization token. However, the authorization server module 600 can be configured to manage a refresh token ID and the term of validity on the authorization token management table 1400. In this case, it is useful to issue both of the authorization token and the refresh token simultaneously so that the authorization server module 600 can transmit a response including the issued refresh token ID in the response of the authorization token.

If the cooperation server module 800 acquires the authorization token, then in step S3.3, the cooperation server module 800 transmits a resource request to the resource server module 700 for the API opened to the public. If the resource server module 700 accepts the resource request, then in step S3.4, the resource server module 700 transmits an authorization token verification request to the authorization server module 600. The authorization token verification request includes an authorization token ID of the verification target authorization token.

In step S3.5, the authorization server module 600 verifies the authorization token acquired from the resource server module 700. The authorization server module 600 acquires information about the authorization token based on the acquired authorization token ID. More specifically, the authorization server module 600 identifies data that is coincident in the authorization token ID and the token type “authorization token” from the authorization token management table 1400 and acquires the term of validity 1403. Then, the authorization server module 600 verifies whether the authorization token is present (more specifically, in the authorization token management table 1400) and verifies whether the authorization token is within the term of validity.

If the result of the authorization token verification reveals that the authorization token is not present or is not within the term of validity although the authorization token is present, the authorization server module 600 determines that the authorization token is “invalid”. Then, in step S3.8, the authorization server module 600 transmits a “refusal response” notification to the resource server module 700. If it is determined that the result of the authorization token verification request is “refusal response”, then in step S4.4, the resource server module 700 transmits an error response to the cooperation server module 800. In step S4.5, the cooperation server module 800 transmits a response including the authority error screen illustrated in FIG. 8C to the web browser 820, and terminates the processing of the flow illustrated in FIG. 7.

If the result of the authorization token verification reveals that the authorization token is present and within the term of validity, the authorization server module 600 determines that the authorization token is “valid”. Then, in step S3.6, the authorization server module 600 performs API upper-limit verification processing. In this case, the authorization server module 600 performs the processing using the user ID and the client ID linked to the authorization token. The API upper-limit verification processing is described in detail below.

If it is determined that the result of the API upper-limit verification processing is “refusal response”, then in step S3.8, the authorization server module 600 transmits a “refusal response” notification to the resource server module 700. If it is determined that the result of the authorization token verification request is “refusal response”, then in step S4.4, the resource server module 700 transmits an error response to the cooperation server module 800. In step S4.5, the cooperation server module 800 transmits a response including the authority error screen illustrated in FIG. 8C to the web browser 820, and terminates the processing illustrated in FIG. 7.

If it is determined that the result of the API upper-limit verification processing is “permission response”, then in step S3.7, the authorization server module 600 performs API number-of-calls addition processing. More specifically, if the API upper-limit verification processing described below is ordinary upper-limit processing, the authorization server module 600 acquires the client ID 1404 from the authorization token management table 1400 based on the acquired authorization token ID. Then, if the acquired client ID coincides with the client ID 1501 in the API number-of-uses upper-limit management table 1500, the authorization server module 600 adds 1 to the number-of-calls per unit term 1506 for the corresponding data.

Further, if the API upper-limit verification processing described below is individual upper-limit verification processing, the authorization server module 600 acquires the client ID 1404 and the user ID 1405 from the authorization token management table 1400 based on the acquired authorization token ID. Further, the authorization server module 600 acquires the tenant ID 1203 from the user management table 1200 based on the acquired user ID. Then, if the acquired client ID and the tenant ID coincide with the set of the client ID 1801 and the permitted tenant ID 1802 in the tenant individual permission setting management table 1800, the authorization server module 600 adds 1 to the number-of-calls per unit term 1804 for the corresponding data. Then, in step S3.8, the authorization server module 600 transmits a “permission response” notification to the resource server module 700. If it is determined that the result of the authorization token verification request is “permission response”, then in step S4.1, the resource server module 700 performs resource acquisition processing according to the API function opened to the public. In step S4.2, the resource server module 700 transmits a response including the acquired resource to the cooperation server module 800. In step S4.3, the cooperation server module 800 transmits a response including a cooperation screen (not illustrated) to the web browser 820 and terminates the processing of the flow illustrated in FIG. 7. Through the above-described processing, the cooperation server module 800 can use the API opened to the public by the resource server module 700.

Performing the API number-of-uses upper-limit verification processing in steps S1.11 and S2.10 brings various effects as described in detail below. For example, the timing for verifying whether the number of API uses has reached the upper limit can be any one of step S1.11, step S2.10, step S3.3, and step S3.6. First, if the above-mentioned verification is performed in step S3.3, more specifically, in a case where the resource server module 700 independently verifies the upper limit of the number of API uses, it is feasible to perform the upper-limit management using detailed API processing information acquired by the resource server module 700. More specifically, it is advantageous in that the upper-limit management can be performed finely compared to the transmission/reception granularity within the category of the OAuth 2.0. On the other hand, in view of the purpose of the present invention (i.e., the reduction of load in the resource server 300), it is necessary for the resource server module 700 to have a module configuration capable of independently managing the upper-limit number of API uses and perform the verification. In other words, the load may increase undesirably. Further, according to a system configuration in which there is a plurality of resource servers 300 that can respectively deploy unique services and open APIs to the public, each resource server 300 is required to have a module configuration capable of managing the upper limit of the number of API uses. In this respect, the above-mentioned configuration is inefficient. Further, each client may have a unique method for managing the upper limit of the number of API uses for each API of the used resource server 300. Therefore, each client is required to perform a complicated processing control.

Next, if the above-mentioned verification is performed only in step S3.6, more specifically, in a case where the resource server module 700 requests the authorization server module 600 to verify whether the number of API uses has reached the upper limit. In this case, for example, even in a case where there is a plurality of resource servers 300 that can respectively deploy unique services and open APIs to the public, it is feasible to realize a uniform method capable of managing the upper limit of the number of API uses. As a result, it becomes easy for each client to perform its own processing control. On the other hand, in view of the purpose of the present invention (i.e., the reduction of load in the resource server 300), as mentioned above, the reduction of the load is not perfect because the resource server module 700 must perform the sequential processing in steps S3.3 to S3.8 even when the number of API uses has reached the upper limit. In particular, the load of the network resource cannot be reduced because it is necessary for the resource server module 700 to establish the communication path via the WAN 100 and the LAN 101 to accept the resource request from the client in step S3.3.

As an example case, the issuance of the authorization token in steps S1.11 and S2.10 may be restricted. In this case, the effect of reducing the load of the resource server 300 (i.e., the purpose of the present invention) is believed to be higher. However, according to the OAuth 2.0, it is general that the authorization token can be reused frequently within the term of validity. The reuse of the authorization token is useful if continuously performing a plurality of APIs is necessary to establish a single service. However, the frequent reuse of the authorization token is disadvantageous in that it is unfeasible to strictly count the number of uses for the purpose of managing the upper limit of the number of API uses. As a result, it may be unfeasible to control the load of the resource server 300 when the authorization token is frequently reused within the term of validity even after the number of API uses has reached the upper limit.

In view of the foregoing, the system according to the present invention can bring a particular effect for the purpose of controlling the load of the resource server 300 by simultaneously restricting the issuance of the authorization token at the timing of the authorization token issuance processing in step S1.11 and step S2.10 in conformity with the method for managing the upper limit of the number of API uses at the timing of the verification processing performed in step S3.6.

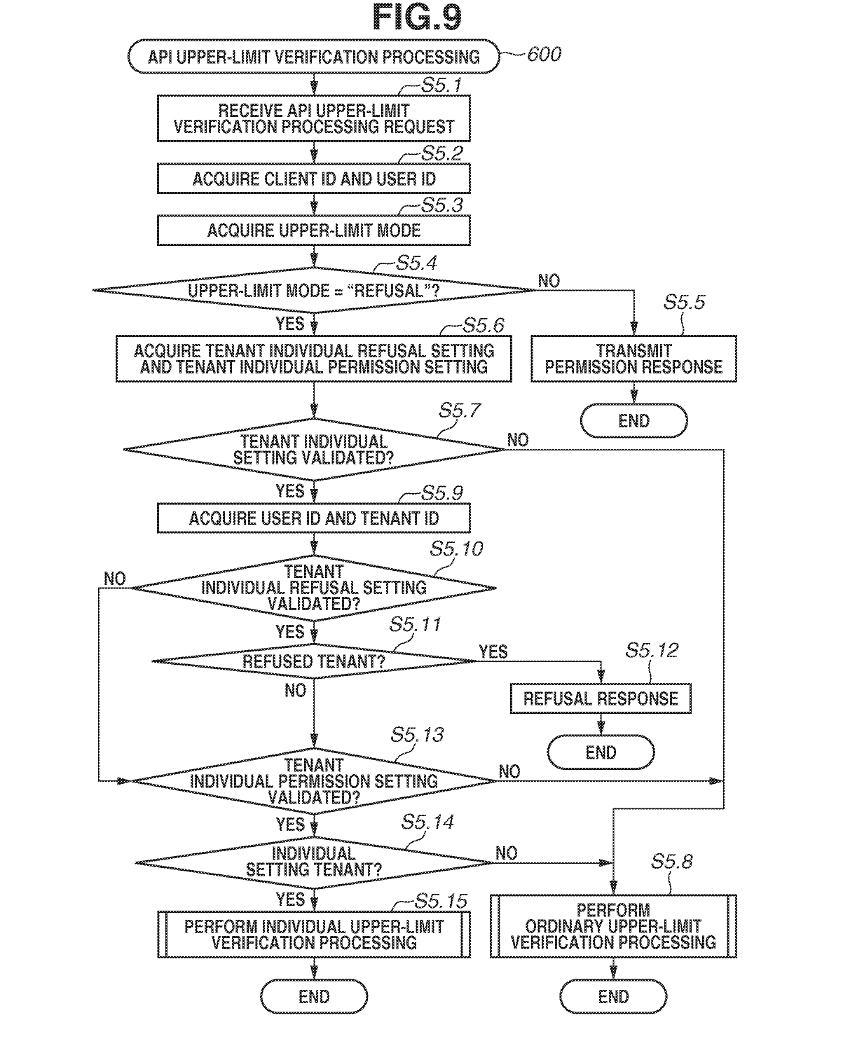

Next, the upper-limit verification processing that can be performed by the authorization server module 600 is described in detail below with reference to FIGS. 9, 10, and 11. FIG. 9 is a flowchart illustrating the API upper-limit verification processing that can be performed by the authorization server module 600. The processing flow illustrated in FIG. 9 can be called and performed in each of steps S1.11, S2.10, and S3.6 in the processing described with reference to FIG. 7. In step S5.1, the authorization server module 600 receives an API upper-limit verification processing request. In step S5.2, the authorization server module 600 acquires the client ID and the user ID notified together with the request. Next, in step S5.3, the authorization server module 600 acquires the upper-limit mode 1505 of the acquired client ID from the API number-of-uses upper-limit management table 1500.

If the acquired upper-limit mode 1505 is “deferred payment for excess” (No in step S5.4), then in step S5.5, the authorization server module 600 transmits a “permission response” notification, and terminates the processing of the flowchart illustrated in FIG. 9. In this case, the type of the upper-limit verification processing included in the notification is ordinary upper-limit verification processing. If the acquired upper-limit mode 1505 is “refusal” (Yes in n step S5.4), then in step S5.6, the authorization server module 600 acquires the tenant individual refusal setting 1602 and the tenant individual permission setting 1603 of the acquired client ID from the tenant individual setting management table 1600.

If both of the acquired tenant individual refusal setting 1602 and the tenant individual permission setting 1603 are “invalidate” (No in step S5.7), then in step S5.8, the authorization server module 600 performs the ordinary upper-limit verification processing. The ordinary upper-limit verification processing is described in detail below. If at least one of the acquired tenant individual refusal setting 1602 and the tenant individual permission setting 1603 is “validate” (Yes in step S5.7), then in step S5.9, the authorization server module 600 acquires a tenant ID based on the acquired user ID. More specifically, the authorization server module 600 acquires the tenant ID 1203 from the user management table 1200 with reference to the user ID. The acquired tenant ID in this case is information required to identify a tenant to which the user who has delegated authority to the client (more specifically, the delegation-of-authority source according to the OAuth 2.0) belongs.

Next, if the authorization server module 600 determines that the acquired tenant individual refusal setting 1602 is “invalidate” (No in step S5.10), the operation proceeds to step S5.13. If the acquired tenant individual refusal setting 1602 is “validate” (Yes in step S5.10), then in step S5.11, the authorization server module 600 confirms whether the tenant of the acquired tenant ID is a refusal target. More specifically, the authorization server module 600 confirms whether the acquired set of client ID and tenant ID is registered in the tenant individual refusal setting management table 1700. If it is determined that the acquired set of client ID and tenant ID is registered (Yes in step S5.11), then in step S5.12, the authorization server module 600 identifies the tenant as a refused tenant and transmits a “refusal response” notification. Then, the authorization server module 600 terminates the processing of the flowchart illustrated in FIG. 9. If it is determined that the acquired set of client ID and tenant ID is not registered (No in step S5.11), the operation proceeds to step S5.13.

In step S5.13, the authorization server module 600 checks the acquired tenant individual permission setting 1603. If it is determined that the acquired tenant individual permission setting 1603 is “invalidate” (NO in step S5.13), then in step S5.8, the authorization server module 600 performs the ordinary upper-limit verification processing. The ordinary upper-limit verification processing is described in detail below. If the acquired tenant individual permission setting 1603 is “validate” (Yes in step S5.13), then in step S5.14, the authorization server module 600 confirms whether the tenant of the acquired tenant ID is an individual setting target. More specifically, the authorization server module 600 confirms whether the acquired set of client ID and tenant ID is registered in the tenant individual permission setting table 1800. If it is determined that the acquired set of client ID and tenant ID is not registered (No in step S5.14), then in step S5.8, the authorization server module 600 performs the ordinary upper-limit verification processing. The ordinary upper-limit verification processing is described in detail below. If it is determined that the acquired set of client ID and tenant ID is registered (Yes in step S5.14), then in step S5.15, the authorization server module 600 performs individual upper-limit verification processing. The individual upper-limit verification processing is described in detail below.

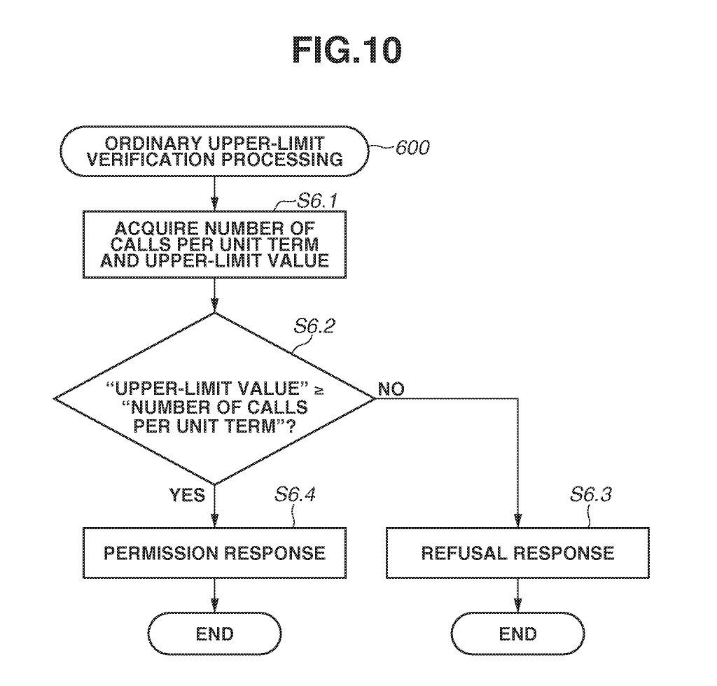

FIG. 10 is a flowchart illustrating the ordinary upper-limit verification processing that can be performed by the authorization server module 600. The processing flow illustrated in FIG. 10 can be called and performed in step S5.8 in the processing described with reference to FIG. 9.

In step S6.1, the authorization server module 600 acquires the upper-limit value 1502 and the number-of-calls per unit term 1506 from the API number-of-uses upper-limit management table 1500 based on the acquired client ID. Then, in step S6.2, the authorization server module 600 confirms whether the number-of-calls per unit term 1506 is equal to or less than the upper-limit value 1502. If it is determined that the number-of-calls per unit term 1506 is greater than the upper-limit value 1502 (No in step S6.2), then in step S6.3, the authorization server module 600 transmits a “refusal response” notification, and terminates the processing of the flowchart illustrated in FIG. 10. If it is determined that the number-of-calls per unit term 1506 is equal to or less than the upper-limit value 1502 (Yes in step S6.2), then in step S6.4, the authorization server module 600 transmits a “permission response” notification, and terminates the processing of the flowchart illustrated in FIG. 10. In this case, the type of the upper-limit verification processing included in the notification is ordinary upper-limit verification processing.

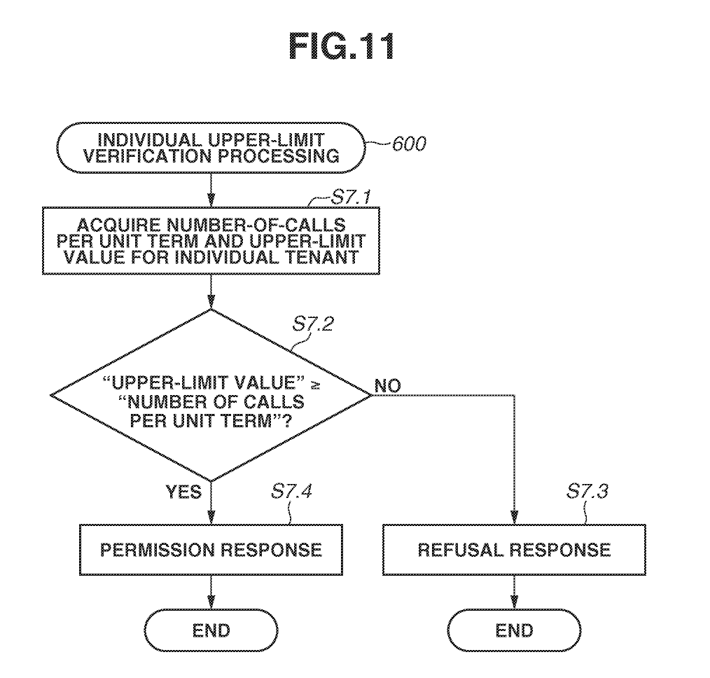

FIG. 11 is a flowchart illustrating the individual upper-limit verification processing that can be performed by the authorization server module 600. The processing flow illustrated in FIG. 11 can be called and performed in step S5.15 in the processing described with reference to FIG. 9.

In step S7.1, the authorization server module 600 acquires the upper-limit value 1803 and the number-of-calls per unit term 1804 from the tenant individual permission setting management table 1800 based on the acquired client ID and the tenant ID. Then, in step S7.2, the authorization server module 600 confirms whether the number-of-calls per unit term 1804 is equal to or less than the upper-limit value 1803. If it is determined that the number-of-calls per unit term 1804 is greater than the upper-limit value 1803 (No in step S7.2), then in step S7.3, the authorization server module 600 transmits a “refusal response” notification, and terminates the processing of the flowchart illustrated in FIG. 11. If the number-of-calls per unit term 1804 is equal to or less than the upper-limit value 1803 (Yes in step S7.2), then in step S7.4, the authorization server module 600 transmits a “permission response” notification, and terminates the processing of the flowchart illustrated in FIG. 11. In this case, the type of the upper-limit verification processing included in the notification is individual upper-limit verification processing.

As described above, the authorization server module 600 performs the upper-limit verification processing. Especially, performing the tenant individual permission setting and the individual upper-limit verification processing enables the user who has delegated authority according to the OAuth 2.0 to manage the upper limit of the number of API uses for each belonging tenant. More specifically, when the API is used by a client, it is feasible to eliminate the deviation with respect to the number of API uses between the delegation-of-authority source tenants.

According to the upper-limit verification processing flow described with reference to the flowchart illustrated in FIG. 9, the authorization server module 600 performs the ordinary upper-limit verification processing if it is determined that the tenant of the acquired tenant ID is not an individual setting target (No in step S5.14). However, according to the processing flow illustrated in FIG. 9, if there is a plurality of tenants that invalidates the tenant individual permission setting, an undesirable deviation with respect to the number of API uses may occur between the non-permission and non-setting tenants.

On the other hand, the provider that deploys the cloud service using the cooperation server 400 is presumed to be different from the providers that deploy the cloud services using the authorization server 200 and the resource server 300. In this case, the security and contract may restrict an administrator of the cooperation server 400 to obtain information about all tenants registered in the user management table 1200 and managed by the authorization server 200. Further, the users registered in the user management table 1200 are not limited to the users of the cooperation server 400. Therefore, it is difficult for the administrator of the cooperation server 400 to perform the tenant individual permission setting beforehand for respective tenants to which all users who use the API of the resource server 300 via the cooperation server 400 belong.

As a result, an undesirable deviation with respect to the number of API uses may occur between two or more tenants that invalidate the tenant individual permission setting.

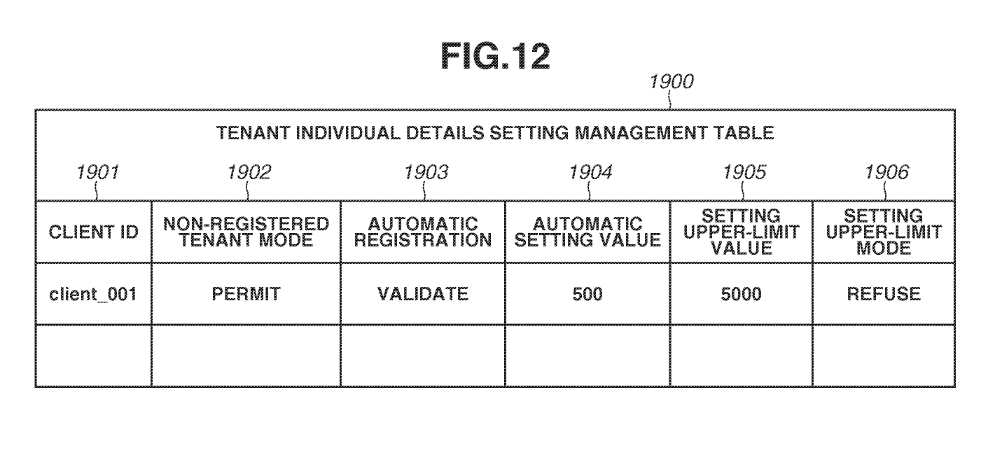

In view of the foregoing, a system capable of solving the above-mentioned problem according to a second exemplary embodiment is described in detail below with reference to FIGS. 12, 13, and 14. A configuration according to the second exemplary embodiment is similar to the above-mentioned configuration according to the first exemplary embodiment, except for FIG. 6C and FIG. 9. Therefore, redundant description thereof will be avoided. Further, configurations and processing similar to those described in FIG. 6C and FIG. 9 are denoted using the same numbers and redundant description thereof will be avoided.

FIG. 12 is a data table stored in the external memory of the database server 500 with which the authorization server 200 according to the second exemplary embodiment can communicate via the LAN 101. Alternatively, the data table illustrated in FIG. 12 can be stored in the external memory of the authorization server 200.

FIG. 12 illustrates a tenant individual details setting management table 1900. The tenant individual details setting management table 1900 is composed of data columns for client ID 1901, non-registered tenant mode 1902, automatic registration 1903, automatic setting value 1904, setting upper-limit value 1905, and setting upper-limit mode 1906. Processing relating to the tenant individual details setting management table 1900 is described in detail below.

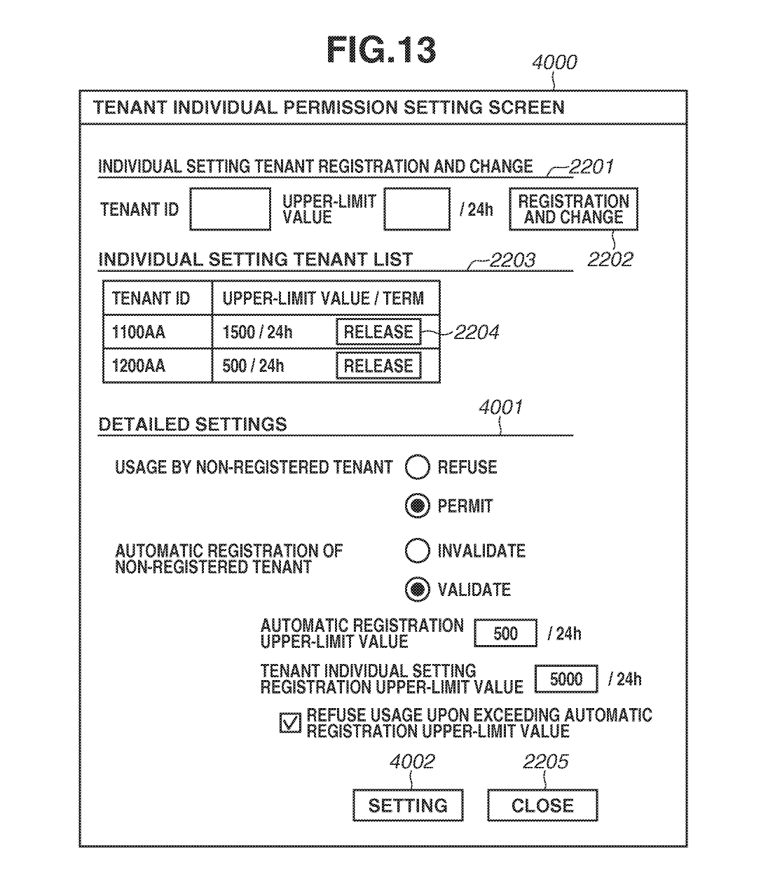

FIG. 13 illustrates a tenant individual permission setting screen 4000. The screen illustrated in FIG. 13 is a screen that can be displayed on the web browser 820 that is available for an administrator or a management delegated user of the cooperation server 400. The screen illustrated in FIG. 13 is a screen that can be generated when the tenant individual permission setting button 2004 is pressed on the API number-of-uses upper-limit management screen 2000 described with reference to FIG. 6A. The tenant individual permission setting screen 4000 includes characteristic features according to the second exemplary embodiment in addition to the contents of the tenant individual permission setting screen 2200 illustrated in FIG. 6C. The same numbers are allocated to constituent components similar to those of the tenant individual permission setting screen 2200 and redundant description thereof will be avoided.

The tenant individual permission setting screen 4000 includes fields for details setting 4001 and setting button 4002 in addition to the configuration of the tenant individual permission setting screen 2200. The setting button 4002 is a button that is operable to set and reflect a selection state of each item in the details setting 4001. If the setting button 4002 is pressed, information relating to “usage by non-registered tenant” operation, “automatic registration of non-registered tenant”, and setting values of “automatic registration” can be notified from the web browser 820 to the authorization server module 600. In response to the notification, the authorization server module 600 reflects the acquired information to each item of the tenant individual details setting management table 1900 with reference to the identified client ID. More specifically, the authorization server module 600 updates the values of the client ID 1901, the non-registered tenant mode 1902, the automatic setting value 1903, the setting upper-limit value 1905, and the setting upper-limit mode 1906 in the tenant individual details setting management table 1900, based on the identified client ID.

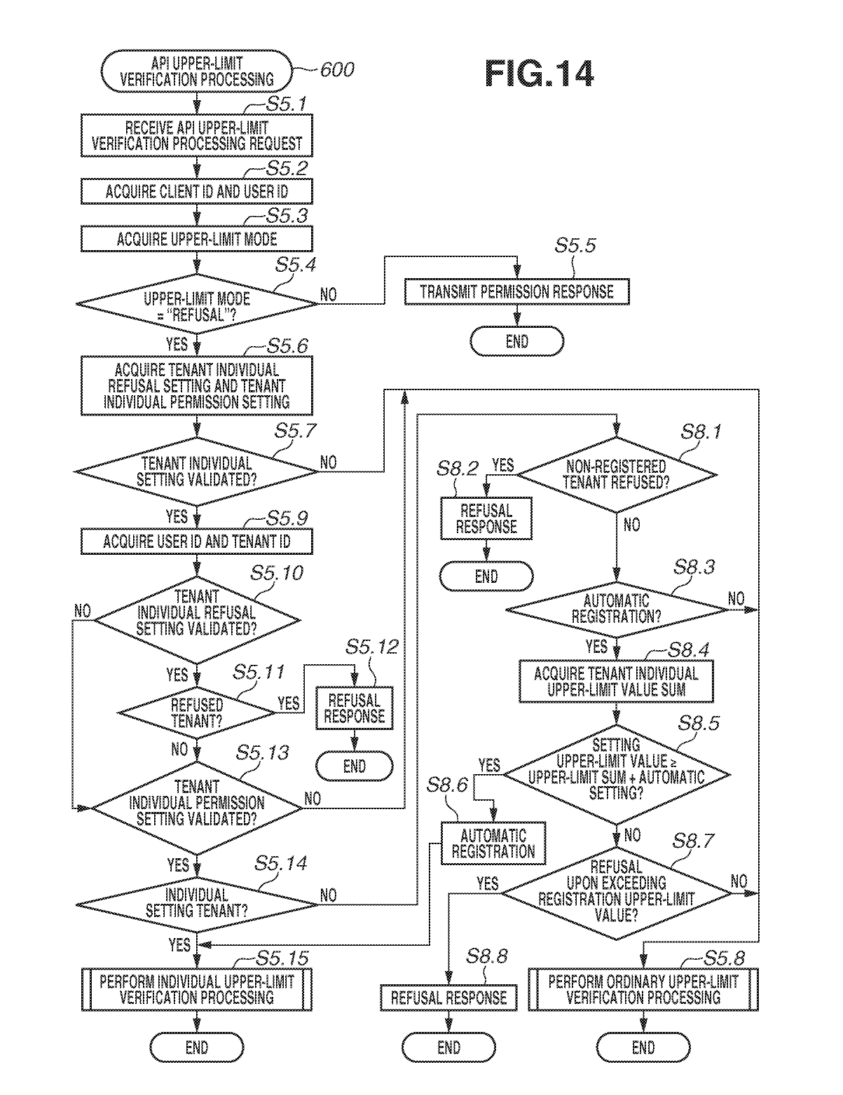

FIG. 14 is a flowchart illustrating API upper-limit verification processing that can be performed by the authorization server module 600. The authorization server module 600 performs the processing illustrated in FIG. 14 when it is called in each processing of step S1.11, step S2.10, and step S3.6 in FIG. 7. The processing flow illustrated in FIG. 14 includes characteristic features of the second exemplary embodiment in addition to the contents of the API upper-limit verification processing flow described with reference to FIG. 9. Steps similar to those already described in the API upper-limit verification processing flow illustrated in FIG. 9 are denoted by the same step numbers and redundant description thereof will be avoided.

In step S5.14, the authorization server module 600 confirms whether the tenant of the acquired tenant ID is an individual setting target. More specifically, the authorization server module 600 confirms whether the acquired set of client ID and tenant ID is registered in the tenant individual permission setting table 1800. If it is determined that the acquired set of client ID and tenant ID is registered (Yes in step S5.14), then in step S5.15, the authorization server module 600 performs individual upper-limit verification processing. If it is determined that the acquired set of client ID and tenant ID is not registered (No in step S5.14), then in step S8.1, the authorization server module 600 confirms the non-registered tenant mode 1902 in the tenant individual detail setting table 1900 based on the acquired client ID. If the non-registered tenant mode is “refusal” (Yes in step S8.1), then in step S8.2, the authorization server module 600 transmits a “refusal response” notification, and terminates the processing of the flowchart illustrated in FIG. 14. If the non-registered tenant mode is “permission” (No in step S8.1), then in step S8.3, the authorization server module 600 confirms the automatic registration 1903 in the tenant individual detail setting table 1900 based on the acquired client ID. If the automatic registration 1903 is “not required” (No in step S8.3), then in step S5.8, the authorization server module 600 performs the ordinary upper-limit verification processing. If the automatic registration 1903 is “required” (Yes in step S8.3), then in step S8.4, the authorization server module 600 acquires the tenant individual upper-limit value sum 1604 from the tenant individual setting management table 1600, and the automatic setting value 1904 and the setting upper-limit value 1905 from the tenant individual details setting management table 1900 based on the acquired client ID.

In step S8.5, the authorization server module 600 confirms whether a sum of the automatic setting value 1904 and the tenant individual upper-limit value sum 1604 is equal to or less than the setting upper-limit value 1905. If it is determined that the above-mentioned sum is equal to or less than the setting upper-limit value 1905 (Yes in step S8.5), then in step S8.6, the authorization server module 600 automatically registers the tenant. More specifically, the authorization server module 600 sets the acquired client ID, tenant ID, and automatic setting value 1904, as upper-limit values, to the tenant individual permission setting management table 1800. Then, in step S5.15, the authorization server module 600 performs the individual upper-limit verification processing. If it is determined that the above-mentioned sum is greater than the setting upper-limit value 1905 (No in step S8.5), then in step S8.7, the authorization server module 600 acquires and confirms the setting upper-limit mode 1906 in the tenant individual detail setting table 1900 based on the acquired client ID.

If the setting upper-limit mode 1906 is “refuse” (Yes in step S8.7), then in step S8.8, the authorization server module 600 transmits a “refusal response” notification, and terminates the processing of the flowchart illustrated in FIG. 14. If the setting upper-limit mode 1906 is “permit” (No in step S8.7), then in step S5.8, the authorization server module 600 performs the ordinary upper-limit verification processing.

Through the above-mentioned processing, the administrator of the cooperation server 400 can set a control to be performed in response to an API usage request from a tenant that invalidates the tenant individual permission setting. Depending on the setting, it becomes feasible to prevent the number of API uses from deviating between two or more tenants that invalidate the tenant individual permission setting.

Further, in the present invention, the client is not limited to a service accessible via the internet. For example, an application installed on a terminal can be a client.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-233498 filed Nov. 11, 2013, which is hereby incorporated by reference herein in its entirety.

What is claimed is:

1. An authorization server system configured to restrict the usage of a service provided via a network, the system comprising:
an authorization processing unit configured to issue authorization information in response to an authorization operation performed to permit a user to delegate authority to use the service to a client;
a verification processing unit configured to verify the authorization information to be transmitted when the client having acquired the authorization information issued by the authorization processing unit uses the service, and configured to permit the client to use the service with the user authority based on a result of the verification;
a determination unit configured to determine whether the number of uses of a mathematical function called by the client to use the service is greater than an upper limit; and
a restriction unit configured to restrict the usage of the mathematical function if the determination unit determines that the number of uses is greater than the upper limit,
wherein the determination unit is configured to determine whether the number of uses of the mathematical function called by the client to use the service is greater than the upper limit when the authorization information is issued by the authorization processing unit and when the authorization information is verified by the verification processing unit.

2. The authorization server system according to claim 1, further comprising:
a holding unit configured to hold a table for registering information in which a group ID for identifying a group to which the user belongs is associated with the upper limit of the number of uses of the mathematical function for each group ID,
wherein the determination unit is configured to identify the group ID corresponding to the user when the client uses the service with the user authority and determine whether the number of uses of the mathematical function called by the client is greater than the upper limit with reference to the upper limit of the number of uses of the mathematical function corresponding to the identified group ID.

3. The authorization server system according to claim 2, further comprising:
a provision unit configured to provide a management screen usable to set refusal and/or permission with respect to the usage of the mathematical function for each group ID,
wherein an error response is performed in response to an access of the client with user authority corresponding to a refused group ID designated via the screen.

4. The authorization server system according to claim 3, wherein the provision unit is configured to provide the management screen to set the upper limit of the number of uses of the mathematical function for a permitted group ID designated via the management screen, and the table held by the holding unit includes registered information about the permitted group ID designated via the management screen in association with the upper limit of the number of uses of the mathematical function having been set on the management screen.

5. The authorization server system according to claim 3, wherein the provision unit is configured to provide the management screen to set refusal or permission with respect to the usage of the mathematical function in response to an access of the client with user authority corresponding to a non-registered group ID for which none of refusal and permission is designated via the management screen, and further the provision unit is configured to provide the management screen to set the upper limit of the number of uses of the mathematical function to be set in automatic registration to the table and to set whether to automatically register the non-registered tenant group ID to the table in response to the access of the client with user authority corresponding to the non-registered group ID.

6. A control method for controlling an authorization server system configured to restrict the usage of a service provided via a network, the method comprising:
causing an authorization processing unit to issue authorization information in response to an authorization operation performed to permit a user to delegate authority to use the service to a client;
causing a verification processing unit to verify the authorization information to be transmitted when the client having acquired the authorization information issued by the authorization processing unit uses the service, and causing the verification processing unit to permit the client to use the service with the user authority based on a result of the verification;
causing a determination unit to determine whether the number of uses of a mathematical function called by the client to use the service is greater than an upper limit; and
causing a restriction unit to restrict the usage of the mathematical function if the determination unit determines that the number of uses is greater than the upper limit,
wherein the determination unit is configured to determine whether the number of uses of the mathematical function called by the client to use the service is greater than the upper limit when the authorization information is issued by the authorization processing unit and when the authorization information is verified by the verification processing unit.

7. The control method according to claim 6, further comprising:
causing a holding unit to hold a table for registering information in which a group ID for identifying a group to which the user belongs is associated with the upper limit of the number of uses of the mathematical function for each group ID,
wherein the determination unit is configured to identify the group ID corresponding to the user when the client uses the service of the user and determine whether the number of uses of the mathematical function called by the client is greater than the upper limit with reference to the upper limit of the number of uses of the mathematical function corresponding to the identified group ID.

8. The control method according to claim 7, further comprising:
causing a provision unit to provide a management screen usable to set refusal and/or permission with respect to the usage of the mathematical function for each group ID,
wherein an error response is performed in response to an access of the client with user authority corresponding to a refused group ID designated via the screen.

9. The control method according to claim 8, wherein the provision unit is configured to provide the management screen to set the upper limit of the number of uses of the mathematical function for a permitted group ID designated via the management screen, and the table held by the holding unit includes registered information about the permitted group ID designated via the management screen in association with the upper limit of the number of uses of the mathematical function having been set on the management screen.

10. The control method according to claim 8, wherein the provision unit is configured to provide the management screen to set refusal or permission with respect to the usage of the mathematical function in response to an access of the client with user authority corresponding to a non-registered group ID for which none of refusal and permission is designated via the management screen, and further the provision unit is configured to provide the management screen to set the upper limit of the number of uses of the mathematical function to be set in automatic registration to the table and to set whether to automatically register the non-registered tenant group ID to the table in response to the access of the client with user authority corresponding to the non-registered group ID.

11. A non-transitory computer-readable storage medium storing a program that causes a computer to execute the control method according to claim 6.
